(19) United States
(12) Patent Application Publication
(10) Pub. No.: US 2025/0044394 A1
(43) Pub. Date: Feb. 6, 2025

(54) INTERFERENCE AREA INFORMATION OUTPUT APPARATUS, INTERFERENCE AREA INFORMATION OUTPUT SYSTEM, INTERFERENCE AREA INFORMATION OUTPUT METHOD, AND RECORDING MEDIUM

(71) Applicant: NEC Corporation, Tokyo (JP)

(72) Inventors: Shigeharu TSUKAGOSHI, Tokyo (JP); Hiroki Tanaka, Tokyo (JP); Minoru Kobayashi, Tokyo (JP)

(73) Assignee: NEC Corporation, Tokyo (JP)

(21) Appl. No.: 18/772,194

(22) Filed: Jul. 14, 2024

(30) Foreign Application Priority Data
Aug. 3, 2023 (JP) 2023-126660

(51) Int. Cl. G01S 1/76

(52) U.S. Cl. CPC G01S 1/76

(57) ABSTRACT

In order to enable more accurate estimation of an interference area for communication using an acoustic wave under water, an interference area information output apparatus, which is connected to a base station performing wireless communication using an acoustic wave with a wireless communication apparatus being present under water, estimates an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source, and outputs interference area information including information relating to the interference area.

This application is based upon and claims the benefit of priority from Japanese Patent Application No. 2023-126660, filed on Aug. 3, 2023, the disclosure of which is incorporated herein in its entirety by reference.

### TECHNICAL FIELD

The present invention relates to an interference area information output apparatus, an interference area information output system, an interference area information output method, and a recording medium.

### BACKGROUND ART

It is conceived to perform communication using an acoustic wave under water. Hereinafter, communication using an acoustic wave under water is referred to as underwater acoustic wave communication in some cases.

An attenuation amount of a radio wave is significantly large in water, and hence an acoustic wave is more suitable for communication in deep water as compared to a radio wave.

In recent years, there has been known a method by which a control apparatus on land or water communicates with a communication apparatus under water via a base station floating on a water surface. When the control apparatus on land or water communicates with the communication apparatus under water via the base station floating on the water surface, communication between the base station and the communication apparatus is performed by underwater acoustic wave communication. Further, communication between the base station and the control apparatus is performed by radio wave communication or wired communication.

Further, techniques described in PTL 1 (Japanese Unexamined Patent Application Publication No. 2010-117205), PTL 2 (Japanese Unexamined Patent Application Publication No. 2012-173224), PTL 3 (Japanese Unexamined Patent Application Publication No. 2013-068553), and PTL 4 (Japanese Unexamined Patent Application Publication No. 2017-181448) are known as the related art.

However, when an interference source is generated, an acoustic wave being transmitted from the communication apparatus or the base station may be interfered, and communication quality may be degraded. The interference source is an object that emits an interference wave. Further, the interference wave is an acoustic wave that may interfere with underwater acoustic wave communication.

In order to prevent an interference wave from affecting underwater acoustic wave communication, it is conceived to change a position of the communication apparatus or change a frequency being used for underwater acoustic wave communication according to, for example, a position of the interference source. However, an influence of the interference wave possibly cannot be prevented under water merely by considering the position of the interference source. Thus, it is desired that an interference area is estimated accurately. The interference area is an area where communication between the communication apparatus and the base station is possibly interfered.

### SUMMARY

In view of the problem described above, an object of the present invention is to provide an interference area information output apparatus, an interference area information output system, an interference area information output method, and a recording medium that enable more accurate estimation of an interference area for communication using an acoustic wave under water.

According to one aspect of the present invention, an interference area information output apparatus is an interference area information output apparatus being connected to a base station performing wireless communication using an acoustic wave with a wireless communication apparatus being present under water, and includes an estimation unit configured to estimate an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source, and an output unit configured to output interference area information including information relating to the interference area.

Further, according to another aspect of the present invention, an interference area information output system is an interference area information output system being connected to a base station performing wireless communication using an acoustic wave with a wireless communication apparatus being present under water, and includes an estimation means for estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source, and an output means for outputting interference area information including information relating to the interference area.

Further, according to another aspect of the present invention, an interference area information output method is an interference area information output method being performed by an interference area information output apparatus being connected to a base station performing wireless communication using an acoustic wave with a wireless communication apparatus being present under water, and includes estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source, and outputting interference area information including information relating to the interference area.

Further, according to another aspect of the present invention, an interference area information output program being recorded in a computer-readable storage medium is an interference area information output program of an interference area information output apparatus being connected to a base station performing wireless communication using an acoustic wave with a wireless communication apparatus being present under water, and causes a computer to achieve an estimation function of estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source, and an output function of outputting interference area information including information relating to the interference area.

According to the above-mentioned aspects of the present invention, it is possible to estimate an interference area more accurately for communication using an acoustic wave under water.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of an interference area information output apparatus according to a first example embodiment of the present invention;

FIG. 2 is a diagram illustrating an example of an operation flow of the interference area information output apparatus according to the first example embodiment of the present invention;

FIG. 3 is a diagram illustrating a configuration example of a communication system including an interference area information output apparatus according to a second example embodiment of the present invention;

FIG. 4 is a diagram illustrating a configuration example of the interference area information output apparatus according to the second example embodiment of the present invention;

FIG. 5 is a diagram illustrating an example of an image indicating an interference area;

FIG. 6 is a diagram illustrating another example of an image indicating an interference area;

FIG. 7 is a diagram illustrating another configuration example of the interference area information output apparatus according to the second example embodiment of the present invention;

FIG. 8 is a diagram illustrating an example of an operation flow of the interference area information output apparatus according to the second example embodiment of the present invention; and

FIG. 9 is a diagram illustrating a hardware configuration example of each of the example embodiments of the present invention.

### EXAMPLE EMBODIMENT

### First Example Embodiment

A first example embodiment of the present invention is described. One specific example of an interference area information output apparatus 10 according to the first example embodiment is an interference area information output apparatus 20 according to a second example embodiment described later.

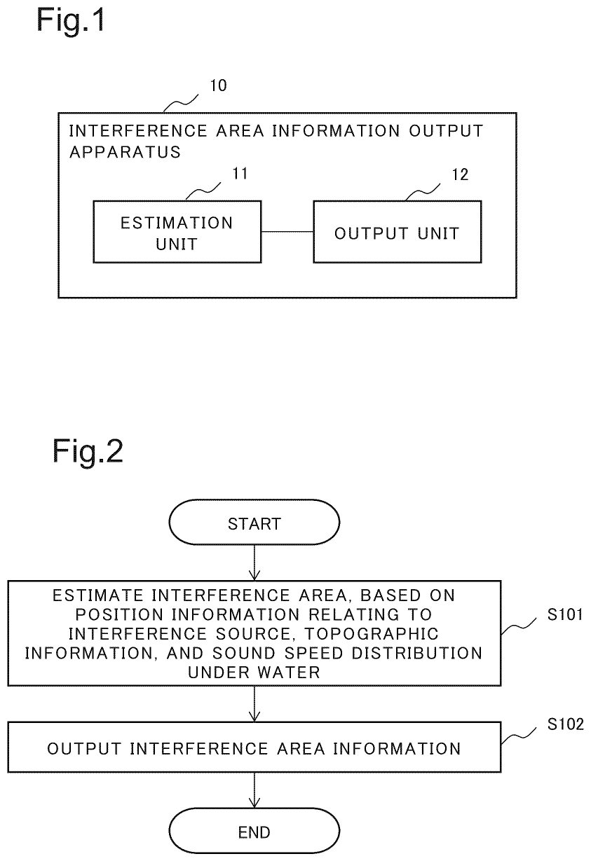

FIG. 1 illustrates a configuration example of the interference area information output apparatus 10 according to the present example embodiment. The interference area information output apparatus 10 includes an estimation unit 11 and an output unit 12.

The interference area information output apparatus 10 is connected to a base station. The base station performs wireless communication using an acoustic wave with a wireless communication apparatus. The wireless communication apparatus is present under water.

The estimation unit 11 estimates an interference area, based on position information relating to an interference source emitting an interference wave, topographic information relating a periphery of the interference source, a sound speed distribution under water in the periphery of the interference source. The interference area is a range where the interference wave possibly interferes with wireless communication.

The interference wave is an acoustic wave that possibly interferes with wireless communication. The interference source is an object that emits the interference wave. The topographic information is information indicating a shape of the land. The sound speed distribution indicates a sound speed at each location under water in the periphery of the interference source.

The output unit 12 outputs interference area information including information relating to the interference area.

Next, FIG. 2 illustrates an example of an operation flow of the interference area information output apparatus 10 according to the present example embodiment.

The estimation unit 11 estimates the interference area, based on the position information relating to the interference source that emits the interference wave with respect to wireless communication, the topographic information relating to the periphery of the interference source, and the sound speed distribution under water in the periphery of the interference source (step S101).

The output unit 12 outputs the interference area information including the information relating to the interference area (step S102).

As described above, in the first example embodiment of the present invention, the interference area information output apparatus 10 includes the estimation unit 11 and the output unit 12. The interference area information output apparatus 10 is connected to the base station. The base station performs wireless communication using an acoustic wave with the wireless communication apparatus. The wireless communication apparatus is present under water. The estimation unit 11 estimates the interference area, based on the position information relating to the interference source that emits the interference wave, the topographic information relating to the periphery of the interference source, and the sound speed distribution indicating a sound speed at each location under water in the periphery of the interference source. The interference wave is an acoustic wave that possibly interferes with wireless communication. The interference area is an area where the interference wave possibly interferes with wireless communication. The output unit 12 outputs the interference area information including the information relating to the interference area.

With this, the topographic information relating to the periphery of the interference source and the sound speed distribution under water in the periphery of the interference source are used for estimation of the interference area. Thus, it is possible to estimate an interference area more accurately for communication using an acoustic wave under water.

### Second Example Embodiment

Next, a second example embodiment of the present invention is described. One specific example of the interference area information output apparatus 10 according to the first example embodiment is an interference area information output apparatus 20 according to the second example embodiment.

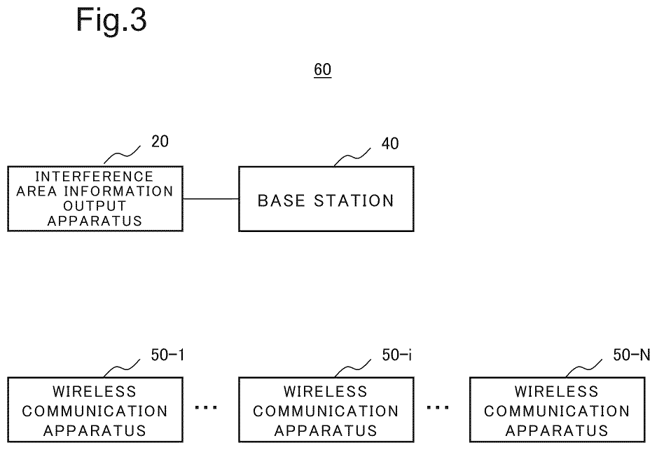

FIG. 3 illustrates a configuration example of a communication system 60 including the interference area information output apparatus 20 according to the present example embodiment. The communication system 60 includes the interference area information output apparatus 20, a base station 40, and a wireless communication apparatus 50-i (i is an integer from 1 to N, and Nis an integer of 1 or greater).

The base station 40 is positioned on water. The base station 40 is capable of performing wireless communication using an acoustic wave with the wireless communication apparatus 50-i.

The wireless communication apparatus 50-i is present under water. The wireless communication apparatus 50-i is capable of performing wireless communication by using an acoustic wave with the base station 40. The wireless communication apparatus 50-i is capable of communicating with the interference area information output apparatus 20 via the base station 40. The wireless communication apparatuses 50-1 to 50-N are collectively referred to as a wireless communication apparatus 50 in some cases.

Further, hereinafter, a frequency being used by the wireless communication apparatus 50-i for wireless communication using an acoustic wave with the base station 40 is referred to as a used frequency. Wireless communication using an acoustic wave may be communication using a band signal. In this case, the used frequency may be a frequency band. When wireless communication refers to communication using a band signal, the term “frequency” refers to a “frequency band”. Further, the used frequencies of the wireless communication apparatuses 50-1 to 50-N may be frequencies different from each other, or may include the same frequency.

The interference area information output apparatus 20 is connected to the base station 40. The interference area information output apparatus 20 is positioned on water or land. The interference area information output apparatus 20 is capable of performing wireless communication using a radio wave or wired communication with the base station 40.

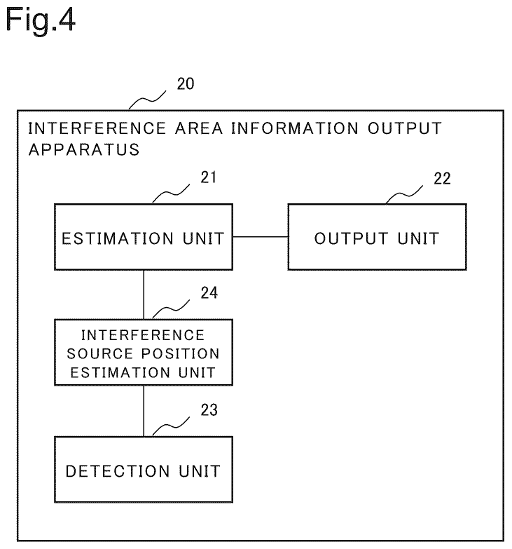

Next, FIG. 4 illustrates a configuration example of the interference area information output apparatus 20 according to the present example embodiment. The interference area information output apparatus 20 includes an estimation unit 21, an output unit 22, a detection unit 23, and an interference source position estimation unit 24.

The estimation unit 21 estimates the interference area, based on the position information relating to the interference source that emits the interference wave, the topographic information relating to the periphery of the interference source, and the sound speed distribution under water in the periphery of the interference source. The interference wave is an acoustic wave that may interfere with wireless communication using an acoustic wave between the base station 40 and the wireless communication apparatus 50-i. For example, a wave of a frequency close to the used frequency of wireless communication of the wireless communication apparatus 50-i or the like may become the interference wave. In a case of wireless communication using an acoustic wave, a sound wave used for communication performed by another business operator, natural sound, sound generated from a construction activity on water, on land, or under water, sound generated from a marine vessel, and the like may also become the interference wave.

The interference source is an object that emits the interference wave. For example, an apparatus that performs communication using an acoustic wave, a marine creature, construction equipment, a marine vessel, and the like may also become the interference source.

The topographic information is information indicating topography. For example, the topographic information indicates seafloor topography. Further, the sound speed distribution indicates a sound speed at each location under water in the periphery of the interference source.

The interference area is a range where the interference wave possibly interferes with wireless communication using an acoustic wave between the base station 40 and the wireless communication apparatus 50-i. A method of estimating the interference area is described later.

For example, specifically, the periphery of the interference source may be a possibly reachable range of the interference wave being emitted from the interference source. The periphery of the interference source may be a range where the interference wave being emitted from the interference source possibly affects wireless communication. Further, the periphery of the interference source may be a range being determined in advance. The periphery of the interference source may be an estimation target range of the interference area, for example, a range within a predetermined distance from the base station 40.

The detection unit 23 detects the interference wave that affects wireless communication using an acoustic wave between the base station 40 and the wireless communication apparatus 50-i. The detection unit 23 is capable of detecting the interference wave by a freely selected method. Examples of a method of detecting the interference wave are described later.

The interference source position estimation unit 24 estimates a position of the interference source that emits the interference wave being detected by the detection unit 23. A method of estimating the position of the interference source is described later.

In the present example embodiment, while the estimation unit 21 estimates the interference area by using the position of the interference source being estimated by the interference source position estimation unit 24, the position of the interference source may be estimated by another apparatus. Further, the interference wave may also be detected by another apparatus.

The output unit 22 outputs the interference area information including the information relating to the interference area being estimated by the estimation unit 21. A method of outputting the interference area information is described later.

Next, description is made on the method of detecting the interference wave. Examples of the method of detecting the interference wave include a method of performing detection, based on an acoustic wave being received by the base station 40, and a method of performing detection, based on an acoustic wave being received by the wireless communication apparatus 50.

First, description is made on the method of detecting the interference wave, based on an acoustic wave being received by the base station 40.

In this case, the base station 40 transmits information relating to an acoustic wave being received to the interference area information output apparatus 20. The information relating to the acoustic wave includes information relating to an arrival direction of the acoustic wave and information relating to a frequency of the acoustic wave. The base station 40 is not required to transmit information relating to an acoustic wave being an acoustic wave used for communication with the wireless communication apparatuses 50-1 to 50-N or an acoustic wave of a frequency not affecting the used frequency of the wireless communication apparatuses 50-1 to 50-N.

For example, when the base station 40 receives any one of the following acoustic waves, the interference area information output apparatus 20 may determine that the interference wave is generated.
An acoustic wave arriving from a direction in which the wireless communication apparatuses 50-1 to 50-N are not present
An acoustic wave arriving from a direction the wireless communication apparatuses 50-1 to 50-N are present and having a frequency different from the used frequency of the wireless communication apparatus present in the direction
An acoustic wave having unknown identification information

Next, description is made on the method of detecting the interference wave, based on an acoustic wave being received by the wireless communication apparatus 50-i.

In this case, the wireless communication apparatus 50-i transmits information relating to an acoustic wave being received to the interference area information output apparatus 20 via the base station 40. The information relating to the acoustic wave includes information relating to an arrival direction of the acoustic wave and information relating to a frequency of the acoustic wave. The wireless communication apparatus 50-i is not required to transmit information relating to an acoustic wave being an acoustic wave used for communication with the base station 40 or an acoustic wave of a frequency not affecting the used frequency of the wireless communication apparatuses 50-1 to 50-N.

Further, when the interference wave is affected, the wireless communication apparatus 50-i cannot perform communication by using the used frequency being used before the interference. Thus, in such a case, the wireless communication apparatus 50-i communicates with the base station 40 by using, among backup frequencies, a frequency not being affected by the interference wave.

The detection unit 23 may detect the interference wave, based on an acoustic wave being received by an information acquisition apparatus (omitted in illustration). For example, the information acquisition apparatus is mounted to an unmanned underwater vehicle (UUV) for information acquisition. In this case, the information acquisition apparatus is capable of detecting the interference wave by using information similar to that in the method of detecting the interference wave, based on an acoustic wave being received by the wireless communication apparatus 50-i.

Next, description is made on the method of estimating the position of the interference source. The position of the interference source is estimated by the interference source position estimation unit 24.

For example, the interference source position estimation unit 24 receives, from the base station 40, information relating to the interference wave being received by the base station 40. The information relating to the interference wave includes information relating to an arrival direction and a frequency of the interference wave. Further, the interference source position estimation unit 24 receives, from the wireless communication apparatus 50-i, the information relating to the interference wave being received by the wireless communication apparatus 50-i. Then, the interference source position estimation unit 24 estimates the position of the interference source by using the information relating to the interference wave being estimated as the interference wave from the same the interference source, among the received pieces of the information relating to the interference waves. For example, the interference source position estimation unit 24 may regard, as the position of the interference source, an intersection point acquired by extending a linear line in the arrival direction of the interference wave from the apparatus (the base station 40 or the wireless communication apparatus 50-i) that receives the interference wave. For example, the interference source position estimation unit 24 may regard the interference waves having the same frequency as interference waves from the same the interference source.

The position of the wireless communication apparatus 50-i may be measured by an inertial sensor provided to the wireless communication apparatus 50-i.

Further, for example, the interference source position estimation unit 24 is capable of estimating the position of the wireless communication apparatus 50-i, based on the direction in which the acoustic wave being emitted from the wireless communication apparatus 50-i arrives at the base station 40. For example, the interference source position estimation unit 24 receives, from the base station 40, the information relating to the arrival direction of the acoustic wave being emitted from the wireless communication apparatus 50-i. Further, the interference source position estimation unit 24 receives information relating to a position (depth degree) of the wireless communication apparatus 50-i in a vertical direction, from the wireless communication apparatus 50-i via the base station 40. Then, the interference source position estimation unit 24 is capable of estimating the position of the wireless communication apparatus 50-i, based on the information relating to the arrival direction and the information relating to the position (depth degree) in the vertical direction. In this case, the wireless communication apparatus 50-i includes a pressure (depth degree) sensor.

Further, the interference source position estimation unit 24 may estimate the position of the interference source, based on a reception signal level of the interference wave. In this case, the information relating to the interference wave further includes information relating to the reception signal level at the apparatus receiving the interference wave.

Next, description is made on the method of estimating the interference area.

The estimation unit 21 is capable of estimating the interference area, based on the position information relating to the interference source that emits the interference wave, the topographic information relating to the periphery of the interference source, and the sound speed distribution under water in the periphery of the interference source.

In the present example embodiment, as described above, the position information relating to the interference source that emits the interference wave, which is a piece of the information being used for estimation of the interference area, is estimated by the interference source position estimation unit 24.

The topographic information relating to the periphery of the interference source is stored in advance in a storage unit (omitted in illustration) inside or outside of the interference area information output apparatus 20. In the present example embodiment, it is assumed that the base station 40 does not travel or travels only by a short distance when it travels. The storage unit stores the topographic information indicating topography under water (for example, a sea floor) in the periphery of the base station 40.

A sound speed under water, for example, a sound speed in the ocean depends on a water temperature, a pressure (depth degree), and a salinity concentration. Thus, the estimation unit 21 may estimate the sound speed distribution in the vertical direction and the horizontal direction, based on at least one of a water temperature in the periphery of the interference source and a salinity concentration. The estimation unit 21 may receive, from the information acquisition apparatus (omitted in illustration), the information being acquired by the information acquisition apparatus, and may estimate the sound speed distribution in the vertical direction and the horizontal direction, based on the information being received.

The information acquisition apparatus acquires the information relating to the depth degree of the information acquisition apparatus. Further, the information acquisition apparatus acquires the information relating to at least one of the water temperature and the salinity concentration in the periphery of the information acquisition apparatus. For example, the information acquisition apparatus includes a depth degree sensor, and acquires the information relating to the depth degree of the information acquisition apparatus. Further, for example, the information acquisition apparatus includes a water temperature sensor, and acquires the information relating to the water temperature in the periphery of the information acquisition apparatus. Further, for example, the information acquisition apparatus includes a salinity concentration sensor, and acquires the information relating to the salinity concentration in the periphery of the information acquisition apparatus. The information acquisition apparatus may be the wireless communication apparatus 50-i. Further, the information acquisition apparatus may be an underwater drone for information acquisition.

With regard to the position of the information acquisition apparatus, a global navigation satellite system (GNSS) cannot be used under water. Thus, the estimation unit 21 may estimate the position of the information acquisition apparatus, based on the direction in which the acoustic wave being emitted from the information acquisition apparatus arrives at the base station 40. For example, the estimation unit 21 receives, from the base station 40, the information relating to the arrival direction of the acoustic wave being emitted from the information acquisition apparatus. Further, the estimation unit 21 receives the information relating to the position (depth degree) of the information acquisition apparatus in the vertical direction, from the information acquisition apparatus via the base station 40. Then, the estimation unit 21 is capable of estimating the position of the information acquisition apparatus, based on the information relating to the arrival direction and the information relating to the position (depth degree) in the vertical direction.

Alternatively, the estimation unit 21 may receive the information from an information server (omitted in illustration). For example, based on information relating to a past water temperature or salinity concentration at a predetermined position or information relating to a past water temperature or salinity concentration in an environment similar to that at the predetermined position, the information server may estimate a current water temperature or salinity concentration at the predetermined position.

Further, the estimation unit 21 is capable of receiving the information relating to the position (depth degree) in the vertical direction, from the wireless communication apparatus 50-i. The wireless communication apparatus 50-i includes a pressure (depth degree) sensor, and acquires the information relating to the position (depth degree) of the wireless communication apparatus 50-i in the vertical direction. Further, similarly to the above-mentioned method, the estimation unit 21 estimates the position of the wireless communication apparatus 50-i.

Further, for example, the estimation unit 21 may simulate propagation of the interference wave, based on the sound speed distribution in the vertical direction and the horizontal direction, by a method described in NPL 1 (Takenobu Tsuchiya, “Numerical Simulation of Sound propagation in Ocean”, The Special Interest Group Technical Reports of Information Processing Society of Japan, June 2019) or the like, and may estimate the interference area.

Further, the estimation unit 21 may estimate the interference area, based on the position of the interference source and a prediction value of the sound speed distribution. For example, the estimation unit 21 may estimate a future interference area, based on a future position of the interference source and a future prediction value of the sound speed distribution. For example, the estimation unit 21 estimates the position of the interference source by a freely selected method. Further, the estimation unit 21 estimates a future water temperature or salinity concentration. The estimation unit 21 may receive information relating to the future water temperature or salinity concentration from an information server. In this state, for example, the information server estimates the future water temperature or salinity concentration at the predetermined position, based on weather forecast information or information relating to a past water temperature or salinity concentration.

The estimation unit 21 is capable of estimating the future position of the interference source by, for example, the following method.

For example, the estimation unit 21 is capable of estimating a speed of the interference source, based on a temporal change of the position of the interference source being estimated by the interference source position estimation unit 24.

Further, for example, the estimation unit 21 may estimate the future position of the interference source by using position information relating to a marine vessel. The estimation unit 21 may receive the position information relating to the marine vessel from a server (omitted in illustration) that provides the same. The information being provided from the serve may be information from an automatic identification system (AIS), for example. Further, the position information relating to the marine vessel may be position information relating to a marine vessel being visually confirmed by an observer on land. Further, the position information relating to the marine vessel may include a history of the past position information.

In this case, the estimation unit 21 estimates a marine vessel being the interference source, based on the position information relating to the marine vessel and the position of the interference source. For example, the estimation unit 21 may estimate, as the interference source, a marine vessel present within a predetermined range from the position of the interference source. When a plurality of (two or more) marine vessels are present within the predetermined range from the position of the interference source, the estimation unit 21 may narrow down the marine vessels to be estimated as candidates of the interference source, based on the temporal change of the position of the interference source.

The estimation unit 21 uses a speed of the marine vessel being estimated as the interference source, as the speed of the interference source. For example, the estimation unit 21 is capable of estimating the speed of the interference source, based on the temporal change of the position information relating to the marine vessel being estimated as the interference source. Further, the estimation unit 21 may use speed information relating to the marine vessel that is included in the information from the AIS, as information relating to the speed of the interference source.

Further, the estimation unit 21 is capable of estimating the future position of the interference source by using the estimation value of the speed of the interference source.

The size of the future interference area is changed by acoustic wave propagation at a travel destination of the interference source or a noise level in the ocean. Acoustic wave propagation is changed by the sound speed distribution depending on a future water temperature or a future salinity concentration, and hence the size of the interference area is changed even when the interference source does not travel. Further, because a water temperature or a salinity concentration is changed due to presence or absence of a rainfall, and a noise level in the ocean is changed due to a wind speed on water, or presence or absence of a rainfall, weather information may be used for estimation of a water temperature or a salinity concentration and estimation of a noise level in the ocean.

Next, description is made on the method of outputting the interference area information.

For example, the output unit 22 may output, as the interference area information, image information for causing a display means (omitted in illustration) to display an image. In this state, the image displayed by the display means may be acquired by superposing an image indicating the interference area on a map.

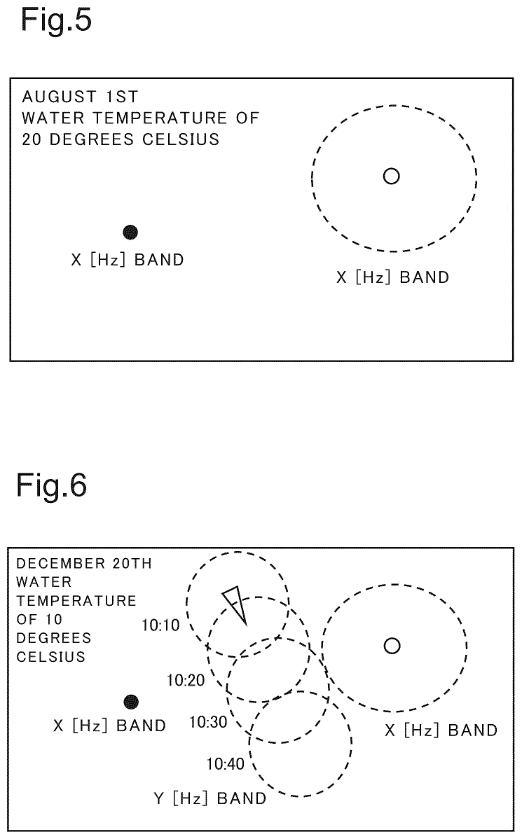

FIG. 5 illustrates an example of an image indicating the interference area. In FIG. 5, the black circle indicates a position of a wireless communication apparatus of an own business operator. Further, the white circle indicates an estimation position of an interference source. Further, the broken-line circle indicates an interference area. In the example of FIG. 5, the interference area is illustrated in a two-dimensional manner, but may be illustrated in a three-dimensional manner.

Further, the interference area information may include the information relating to the past interference area. Further, the interference area information may include information relating to the future interference area. For example, those pieces of information may indicate the temporal change of the travel or size of the interference area by using an image.

FIG. 6 illustrates another example of the image indicating the interference area. In FIG. 6, the triangle indicates a current estimation position of a traveling interference source. Further, FIG. 6 illustrates current and future interference areas.

Further, the interference area information may include the position information relating to the base station 40. Further, the interference area information may include the position information relating to the wireless communication apparatus 50. Further, the interference area information may include the information relating to the used frequency of the wireless communication apparatus 50. Further, the interference area information may include information relating to an area where the communication system 60 provides services. Further, the interference area information may include the position information relating to the marine vessel (the information from the AIS). Further, the interference area information may include the information relating to the sound speed distribution. Further, the interference area information may include the topographic information.

Further, the interference area information may include information indicating the arrival direction of the interference wave towards the base station 40. Further, the interference area information may further include information indicating the reception signal level of the interference wave at the base station 40. In this case, for example, the information indicating the arrival direction may be indicated by an fan-shaped image item indicating an area where the interference source is possibly present. Further, for example, the reception signal level may be indicated by a color of an image item.

When the interference area information described above is output, a user who refers to the interference area information can take measures to avoid an influence of the interference with reference to the interference area information. For example, When the wireless communication apparatus 50 passes through the interference area, a user may change the used frequency of the wireless communication apparatus 50. Further, for example, a user may change the position of the wireless communication apparatus 50. Further, for example, a user may change the position of the base station 40. Further, measures to avoid an influence of the interference may be implemented by a control apparatus (omitted in illustration) to which the interference area information is output.

Further, in underwater acoustic wave communication, an arrival distance of an acoustic wave is changed according to an underwater environment. When the used frequency is changed based on the interference area information that does not consider an underwater environment, the interference wave arrives at the outside of the range being estimated as the interference area, and thus the interference possibly occurs outside of the range being estimated as the interference area. In the present example embodiment, the topographic information relating to the periphery of the interference source and the sound speed distribution under water in the periphery of the interference source are used for estimation of the interference area. Thus, it is possible to estimate an interference area more accurately.

Further, the output unit 22 may further output recommendation information for avoiding the interference with respect to the wireless communication apparatus 50. Further, the output unit 22 may output, as the recommendation information, image information for causing the display means to display an image.

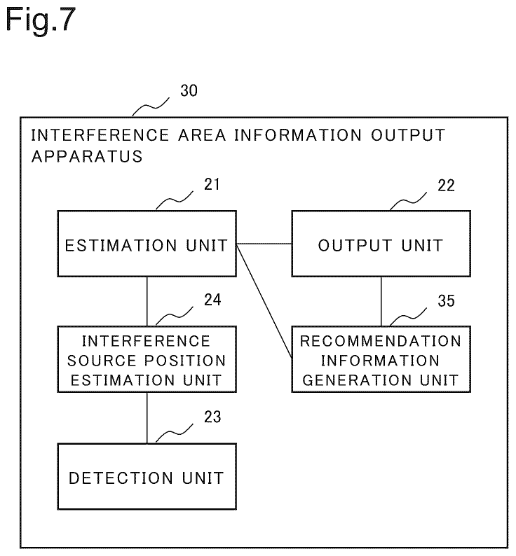

In this case, the interference area information output apparatus may further include a recommendation information generation unit 35. FIG. 7 illustrates a configuration example of an interference area information output apparatus 30 including the recommendation information generation unit 35.

For example, the recommendation information generation unit 35 generates recommendation information for avoiding the interference with regard to the wireless communication apparatus among the wireless communication apparatuses 50 that passes through the interference area. For example, the recommendation information may be information indicating how to avoid the interference by changing a position of the wireless communication apparatus, a used frequency, a transmission acoustic wave level, and the like.

For example, the recommendation information generation unit 35 may regard, as the recommendation information, information relating to a travel route in which the wireless communication apparatus does not pass through the interference area or the shortest travel path to pass through the interference area. Further, for example, when the wireless communication apparatus passes through the interference area, the recommendation information generation unit 35 may regard, as the recommendation information, information relating to a frequency that can alleviate an influence of the interference wave. Further, for example, when it is desired to alleviate an influence of the interference of the acoustic wave transmitted from the wireless communication apparatus on the interference wave, the recommendation information generation unit 35 may regard the reduction of the transmission acoustic wave level as the recommendation information. Further, for example, when it is desired to alleviate an influence of the interference wave on the acoustic wave transmitted from the wireless communication apparatus, the recommendation information generation unit 35 may regard the increase of the transmission acoustic wave level as the recommendation information.

Further, the recommendation information generation unit 35 may schedule the used frequency or the transmission acoustic wave level of the wireless communication apparatus, based on the future interference area, and may regard the information relating to the used frequency or the transmission acoustic wave level being scheduled, as the recommendation information.

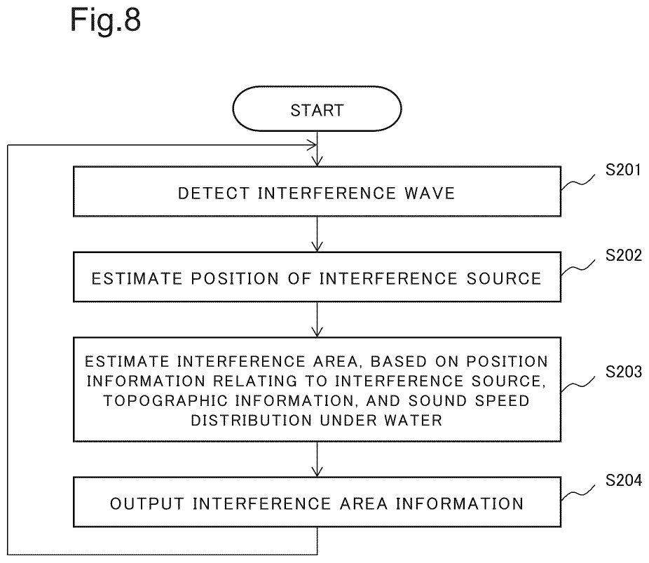

Next, FIG. 8 illustrates an example of an operation flow of the interference area information output apparatus 20.

The detection unit 23 detects the interference wave that affects wireless communication using an acoustic wave between the base station 40 and the wireless communication apparatus 50-i (step S201).

The interference source position estimation unit 24 estimates the position of the interference source that emits the interference wave being detected by the detection unit 23 (step S202).

The estimation unit 21 estimates the interference area, based on the position information relating to the interference source, the topographic information relating to the periphery of the interference source, and the sound speed distribution under water in the periphery of the interference source (step S203).

The output unit 22 outputs the interference area information including the information relating to the interference area being estimated by the estimation unit 21 (step S204).

As described above, in the second example embodiment of the present invention, the interference area information output apparatus 20 includes the estimation unit 21 and the output unit 22. The interference area information output apparatus 20 is connected to the base station. The base station performs wireless communication using an acoustic wave with the wireless communication apparatus. The wireless communication apparatus is present under water. The estimation unit 21 estimates the interference area, based on the position information relating to the interference source that emits the interference wave, the topographic information relating to the periphery of the interference source, and the sound speed distribution indicating a sound speed at each location under water in the periphery of the interference source. The interference wave is an acoustic wave that possibly interferes with wireless communication. The interference area is an area where the interference wave possibly interferes with wireless communication. The output unit 22 outputs the interference area information including the information relating to the interference area.

With this, the topographic information relating to the periphery of the interference source and the sound speed distribution under water in the periphery of the interference source are used for estimation of the interference area. Thus, it is possible to estimate an interference area more accurately for communication using an acoustic wave under water.

Further, by using the interference area information being output, the control apparatus or a user can control the wireless communication apparatus and the base station in such a way as to alleviate an influence of the interference. For example, the position of the wireless communication apparatus, the frequency used for wireless communication between the wireless communication apparatus and the base station, the position of the base station, and the like can be changed.

Further, the estimation unit 21 may estimate the sound speed distribution, based on a water temperature in the periphery of the interference source. With this, the estimation unit is capable of estimating an interference area more accurately for communication using an acoustic wave under water.

Further, the estimation unit 21 may further estimate the sound speed distribution, based on a salinity concentration in the periphery of the interference source. With this, the estimation unit is capable of estimating an interference area more accurately for communication using an acoustic wave under sea water.

Further, the estimation unit 21 may estimate the interference area, based on the position of the interference source and the prediction value of the sound speed distribution. With this, it is possible to implement interference avoidance measures that consider the position of the interference source and changes in the underwater environment.

Further, the estimation unit 21 may estimate the speed of the interference source, and may estimate the position of the interference source by using the estimation value of the speed. With this, a change of the position of the interference source can be estimated.

Further, the output unit 22 may output, as the information relating to the interference area, image information for causing the display means to display an image. With this, the information relating to the interference area can be displayed in a user-friendly manner.

Further, the interference area information output apparatus 20 may further include the detection unit 23 that detects the interference wave and the interference source position estimation unit 24 that estimates the position of the interference source. With this, detection of the interference wave and estimation of the position of the interference source can be achieved by the interference area information output apparatus 20.

### [Hardware Configuration Example]

Description is made on a configuration example of hardware resources for achieving the above-mentioned interference area information output apparatus (10, 20, 30) according to each of the exemplary embodiments of the present invention by using one information processing apparatus (computer). The interference area information output apparatus may be achieved physically or functionally by using at least two information processing apparatuses. Further, the interference area information output apparatus may be achieved as a dedicated apparatus. Further, only some of the functions of the interference area information output apparatus may be achieved by using the information processing apparatus. Further, at least some of the functions of the control apparatus may be achieved on the cloud.

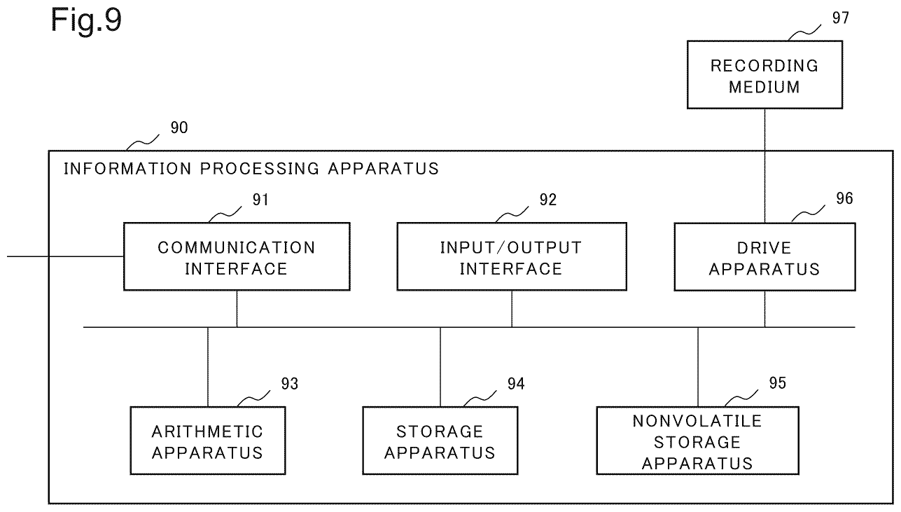

FIG. 9 is a diagram schematically illustrating a hardware configuration example of an information processing apparatus capable of achieving the interference area information output apparatus of each of the exemplary embodiments of the present invention. An information processing apparatus 90 includes a communication interface 91, an input/output interface 92, an arithmetic apparatus 93, a storage apparatus 94, a nonvolatile storage apparatus 95, and a drive apparatus 96.

For example, the output unit 12 in FIG. 1 can be achieved by the communication interface 91 and the arithmetic apparatus 93. The estimation unit 11 can be achieved by the arithmetic apparatus 93.

The communication interface 91 is a communication means for causing the interference area information output apparatus of each of the exemplary embodiments to communicate with an external apparatus in a wired and/or wireless manner. When the interference area information output apparatus is achieved by using at least two information processing apparatuses, those apparatuses may be connected to each other in a communicable manner via the communication interface 91.

The input/output interface 92 is a human machine interface including a keyboard being an example of an input device, a display being an output device, and the like.

The arithmetic apparatus 93 is achieved by an arithmetic processing apparatus such as a general central processing unit (CPU) and a microprocessor and a plurality of electric circuits. For example, the arithmetic apparatus 93 is capable of reading various programs stored in the nonvolatile storage apparatus 95 into the storage apparatus 94 and executing processing according to the read program.

The storage apparatus 94 is a memory apparatus such as a random access memory (RAM) to which the arithmetic apparatus 93 can refer, and stores a program, various data, and the like. The storage apparatus 94 may be a volatile memory apparatus.

For example, the nonvolatile storage apparatus 95 is a nonvolatile storage apparatus such as a read only memory (ROM) and a flash memory, and is capable of storing various programs, data, and the like.

The drive apparatus 96 is an apparatus that execute processing of reading and writing data with respect to a recording medium 97, which is described later, for example.

For example, the recording medium 97 is a freely selected recording medium capable of recording data, such as an optical disk, a magneto-optical disk, and a semi-conductor flash memory.

For example, each of the exemplary embodiments of the present invention may be achieved by configuring the interference area information output apparatus by the information processing apparatus 90 illustrated in FIG. 9 and supplying a program for achieving the functions described in each of the above-mentioned exemplary embodiments to the interference area information output apparatus.

In this case, the program supplied to the interference area information output apparatus is executed by the arithmetic apparatus 93, and thus the exemplary embodiments can be achieved. Further, some of the functions instead of all the functions of the interference area information output apparatus may be configured by the information processing apparatus 90.

Moreover, the above-mentioned program is recorded in the recording medium 97, and the interference area information output apparatus may be configured in such a way that the above-mentioned program is stored as appropriate in the nonvolatile storage apparatus 95 at the time of shipping or operating the interference area information output apparatus. In this case, as the method of supplying the above-mentioned program, there may be adopted a method of installing the program in the interference area information output apparatus by using an appropriate jig at the time of manufacturing before shipping or at the time of operation. Further, as the method of supplying the above-mentioned program, there may be adopted a general procedure such as a method of downloading the program from the outside via a communication line such as the Internet.

The whole or part of the example embodiments disclosed above can be described as, but not limited to, the following supplementary notes.

### Supplementary Note 1

An interference area information output apparatus being connected to a base station performing wireless communication using an acoustic wave with a wireless communication apparatus being present under water, the interference area information output apparatus including:
an estimation unit configured to estimate an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source; and
an output unit configured to output interference area information including information relating to the interference area.

### Supplementary Note 2

The interference area information output apparatus according to supplementary note 1, wherein
the estimation unit estimates the sound speed distribution, based on a water temperature in the periphery of the interference source.

### Supplementary Note 3

The interference area information output apparatus according to supplementary note 2, wherein
the estimation unit estimates the sound speed distribution, further based on a salinity concentration in the periphery of the interference source.

### Supplementary Note 4

The interference area information output apparatus according to any one of supplementary notes 1 to 3, wherein
the estimation unit further estimates the interference area, based on a position of the interference source and a prediction value of the sound speed distribution.

### Supplementary Note 5

The interference area information output apparatus according to supplementary note 4, wherein
the estimation unit estimates a speed of the interference source, and estimates a position of the interference source by using an estimation value of the speed.

### Supplementary Note 6

The interference area information output apparatus according to any one of supplementary notes 1 to 5, wherein
the output unit outputs, as information relating to the interference area, image information for causing a display means to display an image.

### Supplementary Note 7

The interference area information output apparatus according to any one of supplementary notes 1 to 6, further including:
a detection unit configured to detect the interference wave; and
an interference source position estimation unit configured to estimate a position of the interference source.

### Supplementary Note 8

An interference area information output system being connected to a base station performing wireless communication using an acoustic wave with a wireless communication apparatus being present under water, the interference area information output system including:
an estimation means for estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source; and
an output means for outputting interference area information including information relating to the interference area.

### Supplementary Note 9

An interference area information output method being performed by an interference area information output apparatus being connected to a base station performing wireless communication using an acoustic wave with a wireless communication apparatus being present under water, the interference area information output method including:
estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source; and
outputting interference area information including information relating to the interference area.

### Supplementary Note 10

A non-transitory computer-readable storage medium recording an interference area information output program of an interference area information output apparatus being connected to a base station performing wireless communication using an acoustic wave with a wireless communication apparatus being present under water, the interference information output program causing a computer to achieve:
an estimation function of estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source; and
an output function of outputting interference area information including information relating to the interference area.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

1. An interference area information output apparatus being connected to a base station performing wireless communication using an acoustic wave with a wireless communication apparatus being present under water, the interference area information output apparatus comprising one or more memories storing instructions and one or more processors configured to execute the instructions to:
estimate an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source; and
output interference area information including information relating to the interference area.

2. The interference area information output apparatus according to claim 1, wherein
the one or more processors are configured to execute the instructions to estimate the sound speed distribution, based on a water temperature in the periphery of the interference source.

3. The interference area information output apparatus according to claim 2, wherein
the one or more processors are configured to execute the instructions to estimate the sound speed distribution, further based on a salinity concentration in the periphery of the interference source.

4. The interference area information output apparatus according to claim 1, wherein
the one or more processors are configured to execute the instructions to estimate the interference area, based on a position of the interference source and a prediction value of the sound speed distribution.

5. The interference area information output apparatus according to claim 4, wherein
the one or more processors are configured to execute the instructions to estimate a speed of the interference source, and estimate a position of the interference source by using an estimation value of the speed.

6. The interference area information output apparatus according to claim 1, wherein
the one or more processors are configured to execute the instructions to output, as information relating to the interference area, image information for causing display means to display an image.

7. The interference area information output apparatus according to claim 1, wherein the one or more processors are configured to execute the instructions to:
detect the interference wave; and
estimate a position of the interference source.

8. An interference area information output method being performed by an interference area information output apparatus being connected to a base station performing wireless communication using an acoustic wave with a wireless communication apparatus being present under water, the interference area information output method comprising:
estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source; and
outputting interference area information including information relating to the interference area.

9. A non-transitory computer-readable storage medium recording an interference area information output program of an interference area information output apparatus being connected to a base station performing wireless communication using an acoustic wave with a wireless communication apparatus being present under water, the interference information output program causing a computer to achieve:
an estimation function of estimating an interference area being a range where an interference wave possibly interferes with the wireless communication, based on position information relating to an interference source emitting the interference wave being an acoustic wave possibly interfering with the wireless communication, topographic information relating to a periphery of the interference source, and sound speed distribution indicating a sound speed at each location under water in the periphery of the interference source; and
an output function of outputting interference area information including information relating to the interference area.
